(19) United States
(12) Patent Application Publication
(10) Pub. No.: US 2010/0258082 A1
(43) Pub. Date: Oct. 14, 2010

(54) ROTARY CYLINDER BLOCK ENGINE WITH UNEQUAL COMPRESSION AND EXPANSION STROKES

(76) Inventor: Paul Anthony Ryan, Pacific Palisades, CA (US)

Correspondence Address: ITALIA IP, 3500 WEST OLIVE AVE., SUITE 300, BURBANK, CA, 91505, US

(21) Appl. No.: 12/773,157

(22) Filed: May 4, 2010

(51) Int. Cl. F02B 57/08

(52) U.S. Cl. 123/44 E

(57) ABSTRACT

A rotary block engine having unequal compression and expansion characteristics. Pistons carried within the rotary block have rollers which roll across the internal surface of a guide which encircles the rotary block. The rotary block is eccentrically located within the guide, which causes the power and intake strokes to be unequal. Induction and exhaust functions are accommodated by a conduit located at the center of the rotary block, and about which the rotary block rotates. The conduit and the guide are fixed parts of the engine. The rotary block and pistons are moving parts of the engine.

### FIELD OF THE INVENTION

The present invention relates to internal combustion engines, and more particularly to a type of internal combustion engine having a rotatable cylinder block and pistons which are supported within the rotatable cylinder block and which engage guides which encircle the rotatable cylinder block.

### BACKGROUND OF THE INVENTION

The desire to improve efficiency of internal combustion engines has been present ever since internal combustion engines became operable in the nineteenth century. Many different arrangements have been proposed for internal combustion engines, including diverse ways of linking pistons to an output shaft such as a crankshaft, for varying piston displacement, compression ratios, valve timing, and other aspects of engine operation.

Among the principles which have been applied in an effort to improve engine efficiency, the concept of eliminating moving parts has always been a goal. Many designs have been proposed to eliminate reciprocating valves for example. However, some answers to this problem have introduced offsetting consequences. An example is seen in the rotary engine pioneered by Felix Wankel in the 1930's. While Wankel's design did indeed eliminate reciprocating valves, it introduced the situation that the combustion chamber travels around the block, thereby progressively and continuously exposing the combusting environment to a quenching or cooling effect. This impaired thermodynamic efficiency and also caused elevated hydrocarbon output.

The so-called two stroke engine eliminated reciprocating valves and actuating structure, but entailed a breathing scheme which reduces volumetric efficiency of the combustion chamber, as well as diluting the incoming charge of air and fuel with residual exhaust gasses.

Some engine designs sought to vary the expansion ratio relative to the compression ratio. This was accomplished in James Atkinson's nineteenth century design and remains of interest today. However, Atkinson's design requires a piston linkage arrangement requiring more members than the connecting rod which is in general use today.

There remains a need for an engine design which offers greater expansion than compression, while also eliminating piston linkage elements such as connecting rods.

### SUMMARY OF THE INVENTION

The present invention provides an engine design which meets the above stated objective of varying expansion ratio relative to the compression ratio, while eliminating piston linkage elements.

The novel engine has a rotatable cylinder block with radiating cylinders. Pistons which slidably occupy the cylinders and which move radially during their various strokes engage a generally circular guide which encircles the rotatable block. Engagement of this guide is by rollers or the like supported on the pistons, which rollers roll across the inwardly facing surface of the circular guide. The pistons are not unlike conventional valve lifters or tappets which incorporate roller bearings. Of course, in the present inventions, the pistons perform those functions associated with pistons. Comparison to valve lifters is made merely to evoke the image of a roller carried on a cylindrical member. The inwardly facing surface of the guide has relative high points, relative low points, and ramps making transitions between the high and low points. As the pistons exert force against the high and low points during their respective power strokes, and as the pistons roll across the inwardly facing surface during other stoke events, the block is forced to rotate even as the circular guide remains immobile. A rotatable output shaft may be fixed to the rotatable block to harness produced power.

Intake and exhaust functions may be accommodated by a circular shaft located at the center of the block and about which the block rotates. The circular shaft has internal passages and openings that align with openings in the block at appropriate times to effect intake and exhaust breathing.

The circular guide is configured so that piston travel is greater during an expansion stroke than during a compression stroke, thereby achieving the goal of greater expansion than compression strokes.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic cross sectional view of an engine according to the present invention, showing an exemplary piston at the beginning of an intake stroke.

FIG. 2 is similar to FIG. 1, but shows an intermediate stage of the intake stroke.

FIG. 3 is similar to FIG. 1, but shows maximum expansion at the conclusion of the intake stroke.

FIG. 4 is similar to FIG. 1, but shows an intermediate stage of a compression exhaust stroke.

FIG. 5 is similar to FIG. 1, but shows the conclusion of the compression stroke.

FIG. 6 is similar to FIG. 1, but shows an intermediate stage of a power or expansion stroke.

FIG. 7 is similar to FIG. 1, but shows the conclusion of the power or expansion stroke.

FIG. 8 is similar to FIG. 1, but shows an intermediate stage of an exhaust stroke.

FIG. 9 is a diagrammatic perspective view of an engine according to the present invention, with some components omitted to reveal internal detail.

### DETAILED DESCRIPTION

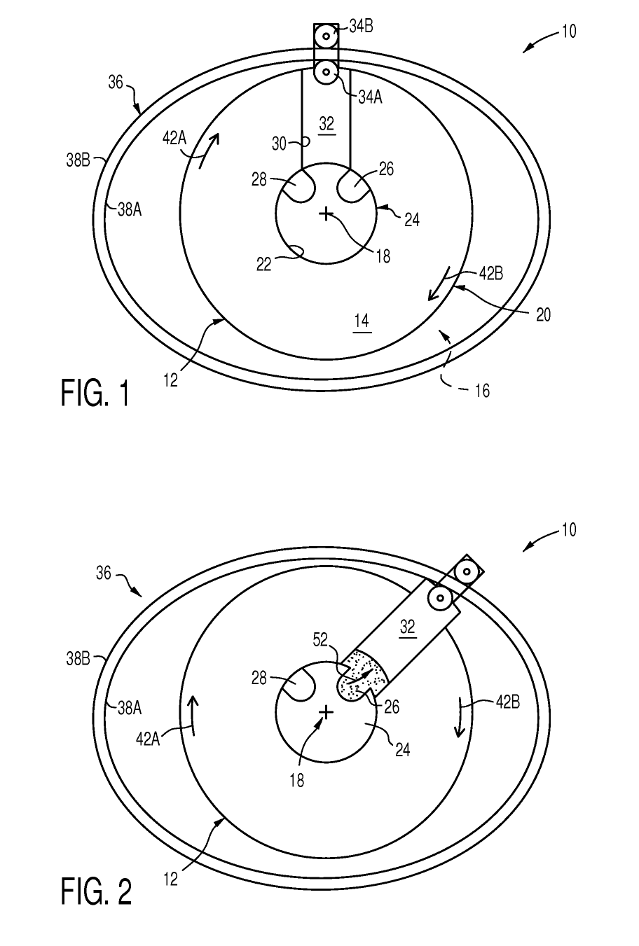

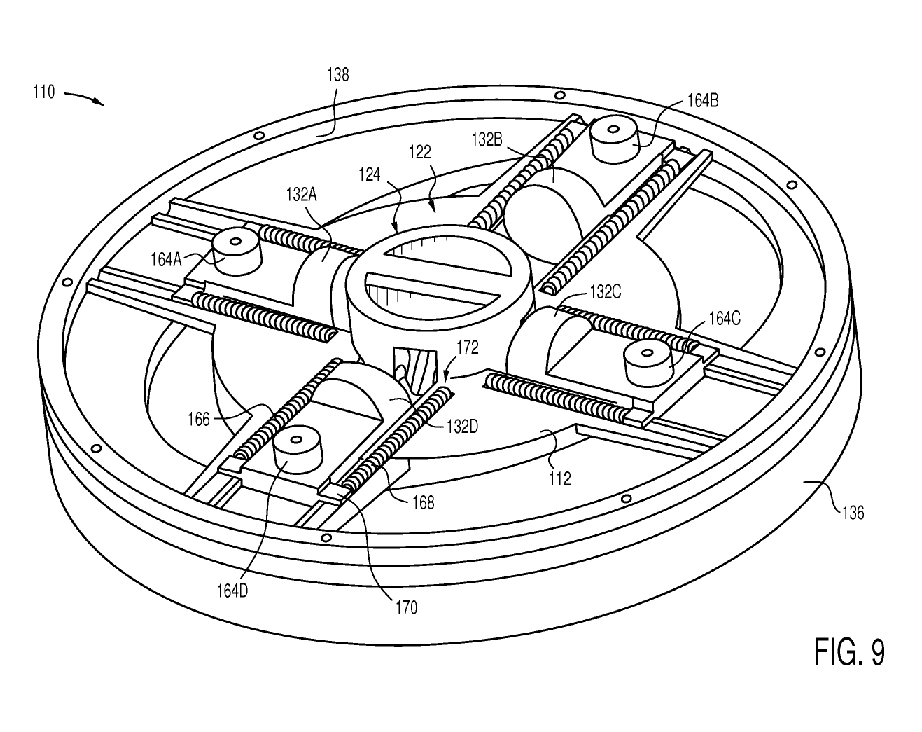

The nature of operation of an engine according to at least one aspect of the invention is shown in FIGS. 1-8. FIGS. 1-8 are diagrammatic or abbreviated in that they show only one piston and cylinder assembly for clarity of understanding, although as will be seen in FIG. 9, an engine according to the present invention may incorporate more than one cylinder in the cylinder block.

FIG. 1 shows an internal combustion engine 10 comprising a rotatable cylinder block 12 configured generally as a disc having a front face 14, a rear face 16, a hypothetical axis of rotation 18 extending from the center of the front face 14 to the center of the rear face 16, and a circumferential outer surface 20 disposed between the front face 14 and the rear face 16. Description of the engine 10 having a front face 14 and a rear face 16 is for semantic purposes only, the front face 14 and the rear face 16 not being critical structural members per se. The rotatable cylinder block 12 defines an open passageway 22 centered around and coaxial with the axis of rotation 18.

The open passageway 22 is occupied by a cylindrical conduit 24. The cylindrical conduit 24 is divided into a first internal flow path 26 and a second internal flow path 28. The first internal flow path 26 serves as an internal induction passage or path communicating with a cylinder bore 30 for periodically supplying combustion air thereto. The second internal flow path 28 serves as an internal exhaust passage or path communicating with the cylinder bore 30 for periodically evacuating spent exhaust gasses. Therefore, the cylindrical conduit 24 will also be referred to as a breathing shaft.

The cylinder bore 30 may be cylindrical, and receives a piston 32 which may reciprocate within the cylinder bore 30, as will be described hereinafter. The cylinder bore 30 is oriented to extend from the open passageway 22 to the circumferential outer surface 20. While only one cylinder bore 30 is shown in FIGS. 1-8, a plurality of corresponding cylinder bores may be provided, as described hereinafter.

The piston 32 operates in conventional fashion, playing a generally conventional role in carrying out the usual functions of a reciprocating piston internal combustion engine (not shown), i.e., induction, compression, power or expansion, and exhaust. Of course, the physical structure and movement of components of the inventive engine 10 differ from those of conventional reciprocating piston internal combustion engines.

Conventionally, each cylinder bore such as the cylinder bore 30 has one piston such as the piston 32. The piston 32 may have roller elements 34A, 34B rotatably mounted thereto.

The roller elements 34A, 34B transfer motive forces to a stationary guide member 36 which encircles the rotatable cylinder block 12. The stationary guide member may present two cam surfaces for engagement with the roller elements 34A, 34B. One roller element 34A engages an internally facing cam surface 38A, while a second roller element 34B engages an outwardly facing cam surface 38B.

It should be mentioned at this point that the cylindrical conduit 24 and the stationary guide member 36 may be referred to as fixed parts, as that term relates to components of an engine which are fixed to or functionally not movable relative to the chassis or frame (not shown) of a vehicle associated with that engine. By contrast, the rotatable cylinder block 12 and the piston 32 may be referred to as moving parts, which move relative to the fixed parts during engine operation.

Because the stationary guide member 36 is a fixed part, forces imposed on the stationary guide member 36 through the roller elements 34A, 34B reactively cause the rotatable cylinder block 12 to rotate about the axis of rotation 18. Power derived from reactive rotation of the rotatable cylinder block 12 may be exploited using an output shaft (not shown) which may be fixed to rotatable cylinder block 12 in any suitable way. For example, an output shaft may be arranged concentrically with respect to the cylindrical conduit 24, and may bear a sprocket, pulley, flange, or other structure to facilitate transfer of torque or power.

The inwardly facing cam surface 38A and an outwardly facing cam surface 38B control position of the piston 32 within the cylinder bore 30 relative to the axis of rotation 18. The geometry or profile of the inwardly facing cam surfaces 38A, 38B include a plurality of relatively high points, a plurality of relatively low points, and ramps providing smooth transition between any of the relatively high points and any adjacent one of the relatively low points, as will be described as each of these features comes into play during the progression of operation shown in FIGS. 1-8.

FIG. 1 depicts the engine 10 as it would be at the beginning of an intake stroke. The piston 32 is at the maximum point of downward travel, as seen in the view of FIG. 1. In the example of FIG. 1, the rotatable cylinder block 12 rotates in a clockwise direction as indicated by the arrows 42A, 42B.

FIG. 2 shows the piston 32 at an intermediate stage of the intake stroke. Inflow of fresh combustion air is indicated by a flow arrow 52 as the fresh combustion air enters the cylinder bore 30 from the first internal flow path 26.

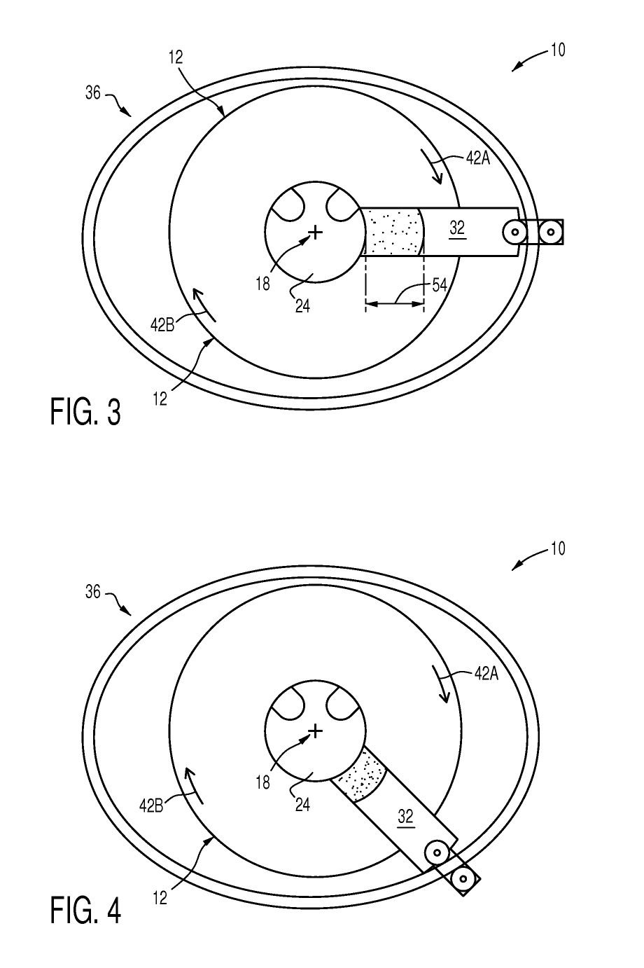

FIG. 3 depicts the conclusion of the intake or induction stroke. The piston 32 has reached its maximal radial outward travel relative to the axis of rotation 18. The magnitude of this travel is indicated by an arrow 54. This travel may be correlated to the travel during the compression stroke, which then proceeds.

FIG. 4 illustrates an intermediate stage of completion of the compression stroke. During the compression stroke, the piston 32 travels radially inwardly towards the axis of rotation 18, compressing the charge of fresh combustion air.

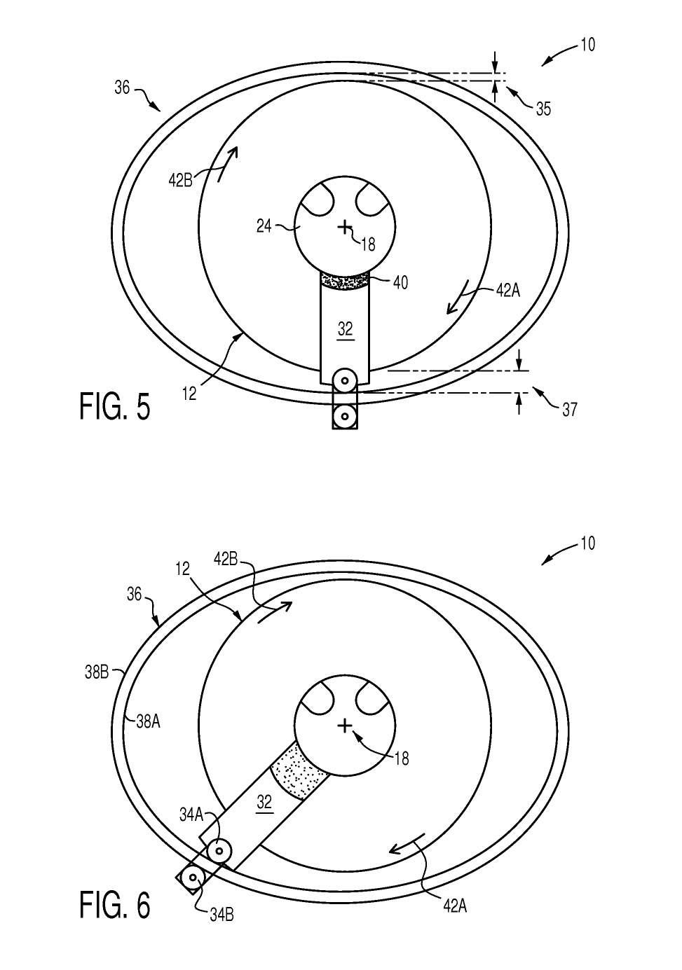

FIG. 5 shows completion of the compression stroke and the point at which the power stroke is about to start. In a spark ignition engine, a spark may occur at this point for example. It will be seen that there is a space 40 located between the cylindrical conduit 24 and the piston 32. By contrast, and referring back to FIG. 1, there was no corresponding space between the cylindrical conduit 24 and the piston 32. This characteristic is produced by a differential in the offset between the axis of rotation 18 and the stationary guide member 36 in the piston positions of FIG. 1 and FIG. 5. This differential may be produced by adjusting position of the axis of rotation 18 with respect to the true center (not indicated) of the stationary guide member 36 such that as depicted in FIG. 5, the axis of rotation 18 is moved to a location slightly below the true center of the stationary guide member 36. The differential is seen as the difference in magnitude of a gap 35 and a gap 37, both indicating distances by which the stationary guide member 36 is spaced apart from the rotatable cylinder block 12. This differential would have the effect of improving scavenging of exhaust gasses from the cylinder bore 30 over that which would result from equal clearances between the rotatable cylinder block 12 and the stationary guide member 36 at the two opposed points just discussed.

FIG. 6 shows an intermediate stage of the power stroke, wherein pressure developing from combustion exerts pressure against the piston 32, which piston 32 is forced outwardly from the axis of rotation 18. Responsively, the rotatable cylinder block 12 rotates clockwise, as indicated by rotation arrows 42A, 42B throughout FIGS. 1-8. The roller elements 34A, 34B respectively contact the inwardly facing cam surface 38A and the outwardly facing cam surface 38B. Coupling of the piston 32 to the stationary guide member 36 in this manner limits radial outward travel of the piston 32 with respect to the axis of rotation 18.

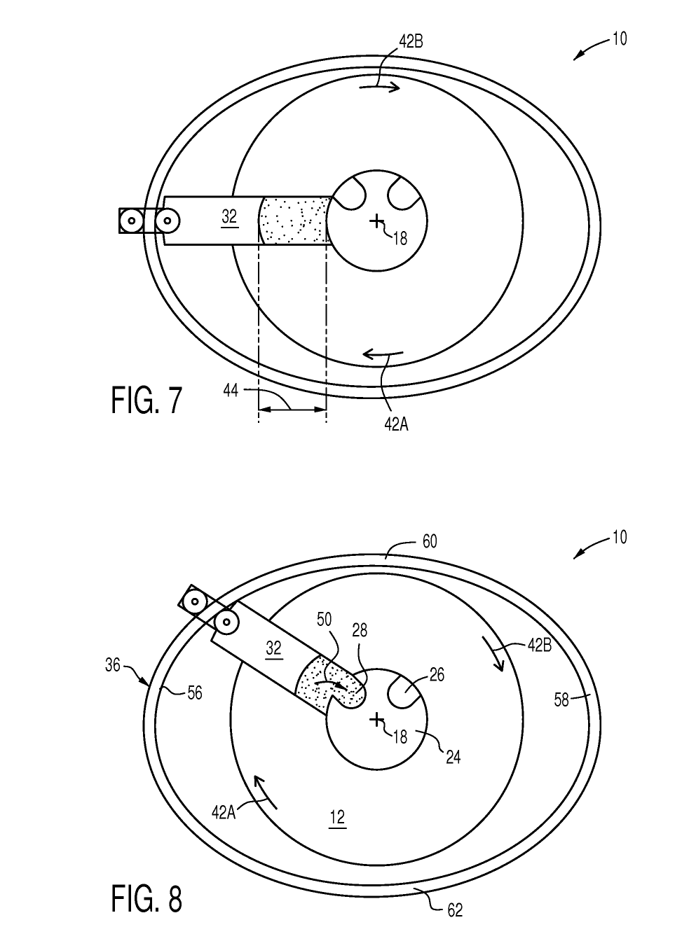

FIG. 7 shows the end of the power stroke and the beginning of an exhaust stroke. An important feature of the invention is revealed by comparing FIG. 3 to FIG. 7. In FIG. 3, the arrow 54, which indicates magnitude of travel of the piston 32 during an intake stroke and also during a compression stroke, is seen to be less than the magnitude of travel of the piston 32 during the expansion or power stroke. The magnitude of travel during the expansion stroke is seen as an arrow 44. The engine 10 thus has greater expansion characteristics than compression characteristics, which leads to increases in theoretical thermodynamic efficiencies.

FIG. 8 shows an intermediate stage of the exhaust stroke, during which spent exhaust gasses are discharged into the second internal flow path 28 or exhaust passage, as indicated by a flow arrow 50. Continued rotation of the rotary cylinder block 12 will return the piston 32 to the position shown in FIG. 1, at which point the engine 10 will be ready to start a new cycle of operation.

Inequality of the compression and expansion strokes, and of the unequal spaces left between the rotary cylinder block 12 and the piston 32, both characteristics having been described priorly, is a function of the profile of the stationary guide member 36. It will be appreciated that the characteristics of the inwardly facing cam surface 38A and the outwardly facing cam surface 38B determine not only relative magnitudes of the compression and expansion strokes, but also the actual compression ratio, and radial piston speeds and stroke magnitudes of the intake, compression, power, and exhaust strokes.

The inwardly facing cam surface 38A and the outwardly facing cam surface 38B are characterized in having two opposed high points 56 and 58 and two intervening opposed low points 60 and 62. Description of these points along the inwardly facing cam surface 38A and the outwardly facing cam surface 38B as being high or low refer to radial distances from the axis of rotation 18 and each one of the high points 56 and 58 and low points 60 and 62. A high point, such as the high points 56 and 58, is at greater distance from the axis of rotation 18 than are low points, such as the low points 60 and 62.

The high point 56 (called out only in FIG. 8) of the stationary guide member 36 is located further from the axis of rotation 18 than is the high point 58 (only called out in FIG. 8), thereby resulting in the difference in magnitude of the arrows 44 (FIGS. 7) and 54 (FIG. 3).

Similarly, the low point 60 is located slightly closer to the axis of rotation 18 than is the low point 62, thereby establishing unequal magnitudes of the gaps 35 and 37 depicted in FIG. 5.

In summary, the inwardly facing cam surface 38A and the outwardly facing cam surface 38B effect piston travel of the piston 32, or of a plurality of pistons, where plural pistons and cylinder bores are provided, such as will be described hereinafter with reference to FIG. 9, such that each one of the pistons undergoes an intake stroke, a compression stroke, a power stroke, and an exhaust stroke, and wherein piston travel is greater during expansion strokes than during compression strokes.

The inwardly facing cam surface 38A and the outwardly facing cam surface 38B also have gradual or ramp-like transitions between each of the relative high points 56 and 58 and relative low points 60 and 62 so that the piston undergoes correspondingly gradual changes in piston speed in the radial directions as the rotatable cylinder block 12 rotates.

Also, it is seen that the breathing shaft or cylindrical conduit 24, and more particularly, the point at which the first internal flow path 26 and a second internal flow path 28 open to the rotatable cylinder block 12, determines timing of breathing events such as induction and exhaust.

FIGS. 1-8 are intended only to explain basic principles of operation of the engine 10. Therefore, not every component which is necessary or advisable for engine operation has been shown in FIGS. 1-8. Also, while only one cylinder bore 30 and piston 32 are depicted, it must not be inferred that an engine according to the present invention is limited to only one cylinder bore and piston.

FIG. 9 shows an exemplary engine 110 having four pistons 132A, 132B, 132C, 132D arranged in cruciform orientation about a cylindrical conduit 124. Each piston 132A, 132B, 132C, or 132D has a roller element which corresponds to the roller elements 34A and 34B of FIGS. 1-8, but which has been omitted from FIG. 9 in order to reveal detail. Supports 164A, 164B, 164C, 164D which would support the omitted roller elements are shown. The pistons 132A, 132B, 132C, and 132D are mounted in respective cylinder bores formed in a rotatable cylinder block 112, but which cannot be fully shown in FIG. 9 due to constraints imposed by the demand for showing internal details. It may be said however that pistons 132A, 132B, 132C, 132D, their associated cylinder bores, a rotatable cylinder block 112, a stationary guide member 136 having an inwardly facing cam surface 138, and the cylindrical conduit 124 are the functional equivalents of their similarly named counterparts of FIGS. 1-8 despite identification by different reference numerals. Apart from modifications necessary to accommodate the plural pistons 132A, 132B, 132C, 132D, the components of the engine 110 may be structural equivalents of their similarly named counterparts of FIGS. 1-8.

The pistons 132A, 132B, 132C, 132D are seen to extend from an open passageway 122, which receives and is occupied by the cylindrical conduit 124 to a circumferential outer surface of the rotatable cylinder block 112. The circumferential outer surface of the rotatable cylinder block 112 is omitted for clarity of the view, but would be equivalent to the circumferential outer surface 20 of the engine 10 of FIGS. 1-8. Similarly, the engine 110 has a plurality of cylinder bores extending from the open passageway 122 to the circumferential outer surface in a radial pattern. As with the circumferential outer surface of the rotatable cylinder block 112, these cylinder bores are omitted, but would be equivalent to the cylinder bore 30 of the engine 10 of FIGS. 1-8.

A further feature which was omitted from FIGS. 1-8 for clarity of view is that of biasing springs disposed to urge each piston 132A, 132B, 132C, or 132D towards the inwardly facing cam surface 138 of the stationary guide member 136. Two such biasing springs 166, 168 are specifically called out by reference numerals; however, it will be seen that each of the remaining pistons 132A, 132B, 132C has equivalent biasing springs not identified by reference numerals. The biasing springs such as the biasing springs 166, 168 are each entrapped by a seat such as a seat 172 formed in the piston 132D and a tab such as the tab 170 formed in the piston 132D.

The pistons 132A, 132B, 132C, 132D may be bilaterally symmetrical in that the side of each piston 132A, 132B, 132C, or 132D which is concealed in the view of FIG. 9 may form a mirror image of that side which is seen in FIG. 9. Bilateral symmetry does not necessarily imply that the number of biasing springs such as the biasing springs 166, 168 is increased from two to four for each piston 132A, 132B, 132C, or 132D. Cooperating structure of the rotatable cylinder block 112 may be modified to accommodate such bilateral symmetry.

An engine according to the present invention, such as the engine 10, may be provided with support functions such as fuel delivery, lubrication, ignition spark generation, and a coolant system (none shown) which may be conventional, apart from redesign considerations which may be necessary to accommodate the rotary block, the pistons, and other structural features.

The present invention is susceptible to modifications and variations which may be introduced thereto without departing from the inventive concepts. For example, the piston 32 could be modified to have only one roller element such as the roller element 34A, if also provided with springs such as the springs 166 and 168 seen in FIG. 9. In such a case, only an inwardly facing cam surface such as the inwardly facing cam surface 38A would be necessary. The outer surface of the respective stationary guide member may be of any desired configuration if it is not necessary to provide an outwardly facing cam surface such as the outwardly facing cam surface 38B.

Also, an engine according to a further aspect of the invention may be provided with a stationary guide member having four high points and four low points, with corresponding changes to the breathing shaft, so that each piston undergoes two full four stroke cycles for each crankshaft revolution.

In a further example, a rotatable cylinder block such as the rotatable cylinder block 12 may be modified to have plural piston and cylinder assemblies located along the axis of rotation.

Also, flow of induction air and exhaust gasses within a breathing shaft, such as the cylindrical conduit 24, may be in the same direction, or could be in opposite directions.

Where practical, any of the optional features of an engine according to the present invention may be combined with one or more other optional features.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An internal combustion engine comprising:
a rotatable cylinder block configured generally as a disc having a front face, a rear face, a hypothetical axis of rotation extending from the center of the front face to the center of the rear face, a circumferential outer surface disposed between the front face and the rear face, an open passageway centered around and coaxial with the axis of rotation, and at least one cylinder bore extending from the open passageway to the circumferential outer surface;
a stationary guide member disposed to encircle the rotatable cylinder block, having an inwardly facing cam surface having a plurality of relatively high points, a plurality of relatively low points, and ramps providing smooth transition between any of the relatively high points and any adjacent one of the relatively low points;
at least one piston, there being one piston for each cylinder bore, each piston having a roller element carried on that side of the respective piston which faces the stationary guide member; and
a breathing shaft having an internal induction passage and an internal exhaust passage, disposed to occupy the open passageway of the rotatable cylinder block and to communicate with each one of the cylinder bores so as to expose each one of the cylinder bores periodically to communication with the internal induction passage and the internal exhaust passage, wherein
the inwardly facing cam surface effects piston travel of each one of the pistons such that each one of the pistons undergoes an intake stroke, a compression stroke, a power stroke, and an exhaust stroke, and wherein piston travel is greater during expansion strokes than during compression strokes.

2. The internal combustion engine of claim 1, wherein the inwardly facing cam surface has a plurality of relatively high points and a plurality of relatively low points disposed between the relatively high points.

3. The internal combustion engine of claim 2, wherein one of the relatively high points of the inwardly facing cam surface is spaced apart from the hypothetical axis of rotation by a distance unequal to that by which another relatively high point is spaced apart from the hypothetical axis of rotation.

4. The internal combustion engine of claim 2, wherein the inwardly facing cam surface has ramps providing smooth transition between any of the relatively high points and any adjacent one of the relatively low points.

5. The internal combustion engine of claim 1, further comprising at least one biasing spring disposed to urge an associated piston against the inwardly facing cam surface.

6. The internal combustion engine of claim 1, comprising two biasing springs for each associated piston, wherein the biasing springs are disposed to urge the associated piston against the inwardly facing cam surface.

7. The internal combustion engine of claim 1, comprising a plurality of cylinder bores formed in the rotatable cylinder block and one piston for each one of the cylinder bores.

8. The internal combustion engine of claim 7, wherein the plurality of cylinder bores comprises four cylinder bores arranged in cruciform orientation.

9. The internal combustion engine of claim 1, wherein each piston is bilaterally symmetrical.

10. The internal combustion engine of claim 1, wherein the stationary guide member has an outwardly facing cam surface having a plurality of relatively high points, a plurality of relatively low points, and ramps providing smooth transition between any of the relatively high points and any adjacent one of the relatively low points, and wherein each one of the pistons comprises a second roller element carried on the piston in a location which contacts the outwardly facing cam surface of the stationary guide member.
